(19) United States
(12) Patent Application Publication
(10) Pub. No.: US 2010/0047543 A1
(43) Pub. Date: Feb. 25, 2010

(54) Transferring films, multilayered sheets and manufacturing methods thereof

(75) Inventors: Kang-Youp Lee, Chungcheongbuk-do (KR); Jin-Woo Kim, Chungcheongbuk-do (KR)

Correspondence Address: LGCHEM;Lerner, David, Littenberg, Krumholz & Mentlik, LLP, 600 South Avenue West, Westfield, NJ, 07090, US

(73) Assignee: LG Chem,Ltd., Seoul (KR)

(21) Appl. No.: 12/308,774

(22) PCT Filed: Jun. 25, 2007
(86) PCT No.: PCT/KR2007/003065

§ 371 Date: Jul. 6, 2009

(30) Foreign Application Priority Data
Jun. 26, 2006 (KR) 10-2006-0057463

(51) Int. Cl. B32B 5/00; C08L 31/04; B32B 37/00; C08L 75/04; C08L 33/02; C08L 83/00; C08K 5/29; C08K 5/1515; C08K 5/10; B32B 27/30; B32B 27/28

(52) U.S. Cl. 428/220; 525/55; 156/60; 525/123; 525/190; 525/221; 524/502; 525/100; 524/197; 524/114; 524/284; 428/500; 428/421; 428/520

(57) ABSTRACT

The present invention relates to a transferring film for manufacturing a decorative laminate sheet having an excellent weatherability, scratch resistance and moldability, a laminate sheet manufactured therefrom and a method for manufacturing thereof. The transferring film and the laminate sheet of the present invention combine an excellent scratch resistance and thermo-formability, since a surface treatment layer comprising a modified acrylic resin and vinyl acetate is formed thereon, and thus may be effectively applied to protect and decorate plastic molded articles such as household appliances, furniture and automobile parts, especially, molded articles having a three-dimensional complicated shape.

### TECHNICAL FIELD

The present invention relates to a transferring film for manufacturing a decorative multilayered sheet (laminate sheet) having an excellent weatherability, scratch resistance and moldability, a laminate sheet manufactured therefrom and a method for manufacturing thereof.

### BACKGROUND ART

There are required physical properties such as chemical resistance, wear resistance, glossiness, image clearness, weatherability and high grade appearance pattern in surfaces of plastic parts used in household appliances, furniture and automobile interior exterior materials. Conventionally, a method such as the spray coating has been used as a method for protecting and decorating surfaces of such plastic molded articles.

However, said coating process repeats generally spraying and drying by 3 times or more, and thus has a problem to take a long time for performing it. For example, time, facility and costs for spraying process in automobile manufacturing processes make up one-third importance in all the processes. Besides, paints used in the spraying process exhaust volatile organic compounds (VOC) to adversely affect the environment. Therefore, additional facility is required to remove these compounds. On recycling articles, thermosetting treatment layers on surfaces have to be removed, and thus there is a problem to cause additional costs.

To overcome said problems of spraying process, it has been tried a method for performing protection and decoration by attaching sheets or films to surfaces of plastic parts. Initially, plasticized polyvinyl chloride (PVC) was used as such a sheet, and then polyvinylidene fluoride film or a composite sheet of a polyvinylidene fluoride resin and a methyl methacrylate resin, having an excellent weatherability and drawing rate, have been developed and used. (International Publication No. WO 88/07416, U.S. Pat. No. 5,514,427, International Publication No. WO 99/37479, JP Patent Publication No. H09-193189, U.S. Pat. No. 5,108,836, and the like)

International Publication No. WO 88/07416 discloses a sheet prepared by applying a mixed composition of a polyvinylidene fluoride resin and a methyl methacarylate resin as a carrier layer on a polyester film and drying the layer. However, in the sheet prepared by the above method, it is restricted to increase hardness of the comprised polyvinylidene resin and methyl methacrylate resin. Thus, there is a problem to lower scratch resistance of surfaces of the completed film.

In addition, various laminate sheets have been developed for protecting and decorating surfaces of plastic molded articles. However, in such conventional laminate sheets, when hardness properties such as scratch resistance are improved, moldability is generally deteriorated. Therefore, there is a need to develop laminate sheets combining said both properties together.

### DISCLOSURE OF INVENTION

### Technical Problem

The present invention relates to a transferring film comprising a surface treatment layer including a modified acrylic resin and a vinyl acetate resin

### Technical Solution

The transferring film of the present invention has an excellent surface hardness, since ingredients included in the surface treatment layer have strong polarity and inter-molecular binding force. In addition, the transferring film of the present invention has also an excellent drawing rate of surface treatment layer and an excellent scratch resistance and moldability on applying it on molded articles and prevents appearance damage such as generation of cracks even after thermoformation, and thus may be effectively applied on plastic injection molded articles.

### BRIEF DESCRIPTION OF THE DRAWINGS

FIG. 1 is a cross-sectional view schematically depicting a transferring film according to one aspect of the present invention.

FIG. 2 is a cross-sectional view schematically depicting a laminate sheet according to one aspect of the present invention.

FIG. 3 is a process diagram of preparing a laminate sheet according to one aspect of the present invention.

FIG. 4 is a configuration diagram schematically depicting a method for molding molded articles using a laminate sheet according to one aspect of the present invention as a use for decorating surfaces.

FIG. 5 is a configuration diagram schematically depicting a method for molding molded articles using a laminate sheet according to another aspect of the present invention as a use for decorating surfaces.

### BEST MODE FOR CARRYING OUT THE INVENTION

The transferring film of the present invention is described in detail below.

The surface treatment layer in the transferring film of the present invention comprises a modified acrylic resin and a vinyl acetate resin. Its thickness is preferably 3 to 20□, but not limited thereto.

The modified acrylic resin and the vinyl acetate resin included in the surface treatment layer serve to give the surface treatment layer scratch resistance and thermo-formability. Specifically, said modified acrylic resin improves hardness of the surface treatment layer due to high intermolecular polarity and binding force and improves drawing rate together. Therefore, the surface treatment layer included in the transferring film of the present invention has an excellent hardness property such as scratch resistance and also an excellent moldability, and prevents generation of defects such as cracks after molding. Examples of the usable modified acrylic resin in the present invention include, but not limited to, one or more selected from the group consisting of urethane acrylate, amine grafted acrylate and maleic acid grafted acrylate. In addition, preferably, the modified acrylic resin is included in an amount of 15 to 25 parts by weight and the vinyl acrylate resin is included in an amount of 5 to 15 parts by weight, in the surface treatment layer. If each amount of ingredients is departed from the above ranges, the desired scratch resistance or moldability is not obtained or economical efficiency threatens to be lowered.

Preferably, the surface treatment layer of the present invention also further comprises 0.5 to 1 part by weight of wax. Said wax gives the surface treatment layer slipperiness and thus serves to reinforce damage resistance. If the amount is departed from the above ranges, the desired effect is not obtained or economical efficiency threatens to be lowered.

Preferably, the surface treatment layer of the present invention also further comprises 0.1 to 0.5 parts by weight of a silicone resin. Said silicone resin makes leveling efficient, on coating the surface treatment layer, and also gives the surface treatment layer slipperiness and thus serves to reinforce damage resistance.

Preferably, the surface treatment layer of the present invention also further comprises 1 to 10 parts by weight of a hardener. Such a hardener may additionally improve hardness of the surface treatment layer. Examples of the usable hardener in the present invention include, but not limited to, one or more selected from the group consisting of isocyanate compounds such as methyl diisocyanate or toluidine diisocyanate, multivalent epoxy compounds and activated polyester compounds.

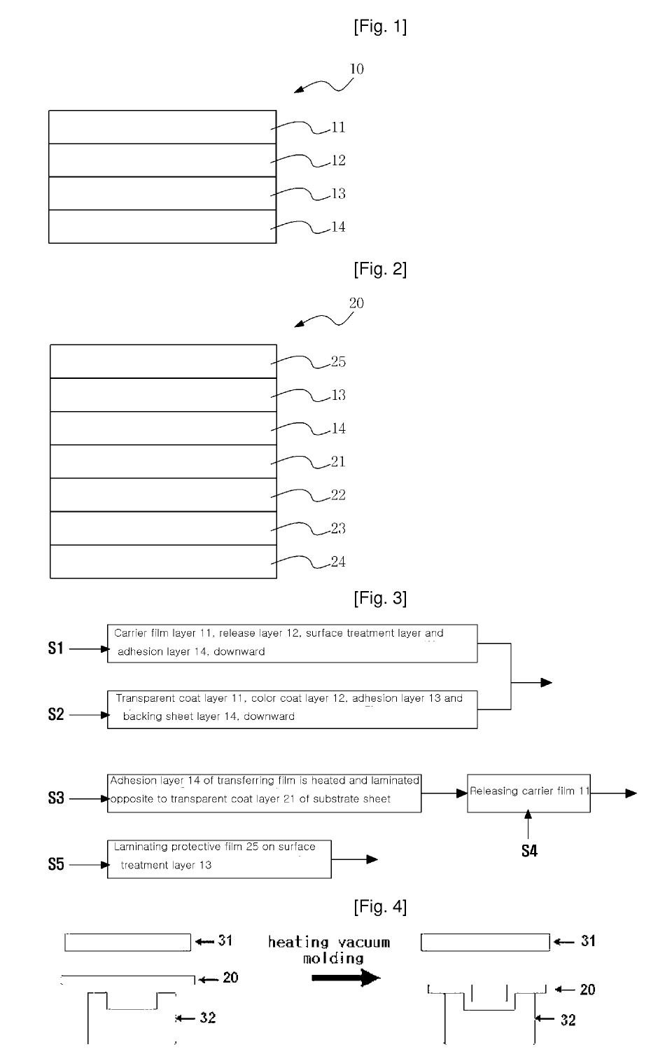

As shown in FIG. 1, the transferring film of the present invention may comprises a carrier layer 11 and a release layer 12 laminated in order on a surface treatment layer 13, and an adhesion layer 14 formed below the surface treatment layer 13.

Said carrier layer may consist of materials usually used in this field, which is not specifically limited. Examples of the materials composing said carrier layer include a thermoplastic resin film having a softening temperature of 200° C. or more. A polyethyleneterephthalate film or a high density polypropylene film is preferred in that it has an excellent surface gloss. In addition, although a thickness of said carrier layer is not specifically limited, it is preferred to regulate a thickness of said carrier layer in a range of 25 to 100□.

A release layer may be formed below said carrier layer. Also, materials composing the release layer are not specifically limited and may use usual ones known in this field. Such examples include a silicone resin releasing agent or a melamine resin releasing agent. In addition, a thickness of said release layer is preferably 0.1 to 0.5□, but not limited thereto.

The adhesion layer formed below said surface treatment layer is also not specifically limited, and may be constituted using usual adhesives in this field. Examples of such adhesives include urethane acrylate or acryl amine copolymer resin-based adhesives. Such adhesives are preferred in that they have an excellent adhesion with the upper surface treatment layer and an excellent adhesion with objects such as substrate sheets on thermal transfer.

The above transferring film of the present invention may be prepared, using the materials described above, by a usual method in this field

For example, the transferring film of the present invention may be prepared via a method comprising a first step of forming a release layer on a substrate film; a second step of applying a composition for forming a surface treatment layer on said release layer and drying the resultant layer to form the surface treatment layer; and a third step of forming a adhesion layer on said surface treatment layer.

The first step is a step of forming a release layer on a substrate film, materials of which the substrate film and the release layer are as described above. The method of forming the release layer is not specifically limited, and the layer may be formed by usual methods such as bar coating, slot-die coating, mayer bar coating, nip coating or gravure coating.

The second step is a step of applying a composition for forming the surface treatment layer on the release layer formed as above and drying the composition to form the surface treatment layer. The composition for forming a surface treatment layer may be prepared by dissolving each component, composing the surface treatment layer, as described above in a solvent.

As a solvent for preparing the composition for forming the surface treatment layer, it is preferred to use a mixed solvent of toluene, methyl ethyl ketone and ethyl acetate. In the present invention, a viscosity of the composition for forming the surface treatment layer may be appropriately regulated for forming the surface treatment layer by regulating each amount of components, using said mixed solvent, wherein the viscosity of composition regulated by the solvent is preferably 10 to 200 cps. If the viscosity is less than 10 cps, it is apprehended to cause defects of sagging. If the viscosity is in excess of 200 cps, the revelling performance is lowered and thus defects of coating threaten to be caused. Although each amount of components included in the mixed solvent is not specifically limited as long as the composition is regulated so that it may have said viscosity, it is preferred that the mixed solvent comprises 25 to 35 parts by weight, 15 to 20 parts by weight of methyl ethyl ketone, and 10 to 15 parts by weight of ethyl acetate.

The method for forming the surface treatment layer using said composition for forming the surface treatment layer is not specifically limited. For example, the method includes a method of coating the composition for forming the surface treatment layer on the release layer in a thickness of 3 to 30□ and then drying the coating at a temperature of 110 to 150° C. for an appropriate time. The method for applying the composition for forming the surface treatment layer is also not specifically limited, but may use the coating method used in forming the release layer as described above. It is preferred to use mayer bar coating or slot-die coating in view of easy regulation of thickness.

Said third step is a step of forming an adhesion layer on the formed surface treatment layer in the second step. The adhesion layer may be formed via usual methods in this field. For example, the method includes a method of coating a urethane acrylate or acryl amine copolymer resin based adhesive on the surface treatment layer in a thickness of 1 to 5□ by bar coating or mayer bar coating, and the like, and then drying the coating at a temperature of 100 to 150° C. for an appropriate time.

The present invention also relates to a laminate sheet comprising a surface treatment layer transferred from a transferring film according to the present invention. The present invention may give the laminate sheet an excellent scratch resistance and moldability by transferring the surface treatment layer to the laminate sheet via said transferring film.

In addition to said transferring film, particularly, the surface treatment layer of transferring film, the laminate sheet of the present invention may comprises additional layers usually applied in this field.

For example, the laminate sheet of the present invention may be laminated on the surface treatment layer 13 by a protective film layer 25 and formed below the layer by an adhesion layer 14, a transparent coat layer 21, a color coat layer 22, an adhesive layer 23 and a backing sheet layer 24 in order, as shown in FIG. 2. The laminate sheet as shown in FIG. 2 is just one aspect of the present invention, wherein each layer may be omitted, if need, or other layers rather than the layers shown in FIG. 2 may be appropriately added.

The protective film layer may be formed using usual resin films in this field. Its examples include a polyethylene film or a polypropylene film.

In the laminate sheet of the present invention, a transparent coat layer may be formed below the surface treatment layer via the adhesion layer. Materials comprising said transparent coat layer are not specifically limited and usual resins in this field, but preferably resins with weatherability, may be used without any limitation. Examples of such resins include a polyvinylidene fluoride resin, a methyl methacrylate resin, or a resin blended or co-extruded from a polyvinylidene fluoride resin and a methyl methacrylate resin. In addition, said transparent coat layer has preferably a thickness in a range of 0.1 to 200□.

In the laminate sheet of the present invention, a color coat layer may be further formed below the surface treatment layer. Said color coat layer may be formed using mixtures of various inks and binder resins. Preferably, ones having an excellent weatherability are used as inks.

In the laminate sheet of the present invention, a backing sheet layer may be also further formed below the surface treatment layer. Materials forming the backing sheet layer are not specifically limited. A usual sheet such as an ABS sheet may be used. Preferably, said backing sheet layer has a thickness in a range of 0.1 to 1 mm. As shown in FIG. 2, said backing sheet may be adhered via an adhesion layer, wherein the adhesion layer may be formed using various adhesives known in this field. For example, said adhesion layer may be formed from adhesives being acrylic resins, urethane resins or urethane acrylate copolymer resins.

The present invention relates to a process for preparing a laminate sheet comprising steps of

(1) preparing a weatherable substrate sheet; and

(2) transferring a surface treatment layer on the substrate sheet using the transferring film according to the present invention.

The step (1) of the present invention is a step of preparing a substrate sheet for a surface treatment layer of a transferring film to be transferred thereon. A method for preparing the substrate sheet is not specifically limited. The sheet may be prepared by usual methods in this field, depending on the structure of substrate sheet. For example, if the substrate sheet comprises a transparent coat layer, a color coat layer and a backing sheet layer, it may be prepared by forming the color coat layer and the adhesion layer in order on the transparent coat layer and then laminating the backing sheet. Materials used in each step above are as described above.

The step (2) of the present invention is a step of laminating a transferring film on the weatherable substrate sheet prepared in the step (1) to transfer a surface treatment layer. A method for laminating the transferring film is not specifically limited, and may use a method known in this field.

An example of such laminating method is as follows:

First, the weatherable substrate sheet prepared in step (1) is preheated to a temperature of 100 to 150° C. in a preheating roll, and then heated to a temperature of 160 to 175° C. in a heating drum to be softened. Subsequently, the adhesion layer of the transferring film heated to a temperature of 130 to 160° C. by an infrared heater and the like is adhered opposite to the transparent coat layer of said substrate sheet, and passed between a rubber roll and a steel roll to laminate the transferring film and the substrate sheet. Therefore, step (2) may be performed by such processes.

The method for preparation of the present invention may further comprise a step of laminating a protective film on the transferred surface treatment layer. If a carrier layer is formed on the transferring film, the protective film is laminated after releasing the layer. Since a release layer is formed below the carrier layer, the carrier layer may be easily released. Examples of a method for forming a protective layer after releasing the carrier layer may include a method for laminating a protective film such as a polyethylene film or a polypropylene film, wherein a pressure-sensitive adhesive is applied to one side, using a lamination roll.

The present invention also relates to an injection molded article comprising the laminate sheet according to the present invention.

As described above, the transferring film of the present invention and the laminate sheet constituted using the same have an excellent weatherability, moldability and scratch resistance. Therefore, the laminate sheet of the present invention may be advantageously used in decorating various molded articles for household appliances, furniture, automobiles, and the like. In addition, when the laminate sheet of the present invention is a plastic molded article prepared by injecting a melt resin, it may be applied, without restricting to uses that molded articles are used. Especially, if the surface of molded article is formed by a complicated shape such as a three-dimensional curve, it shows more excellent performance.

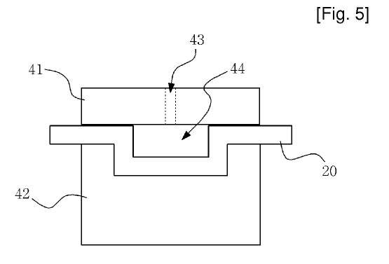

In the attached FIGS. 4 and 5, a method that the laminate sheet according to one aspect of the present invention is used in surface decoration of an injection molded article is depicted.

Specifically, the laminate sheet 20 according to the present invention is positioned on a mold 32, as shown in FIG. 4. Next, the sheet is pre-molded at a temperature of 180 to 250° C. by hot plate 31 and the like, using usual vacuum molding. Then, the laminate sheet 20 is inserted in an injection machine equipped with an upper mold 41 and a bottom mold 42 as shown in FIG. 5, and the molten resin 44 is injected through an injection hole 43. The laminate sheet of the present invention may be applied to surface decoration by such an injection molding.

The present invention is described in more detail below, regarding examples in accordance with the present invention and comparative examples not in accordance with the present invention. But, the scope of the present invention is not restricted to the examples indicated below.

### EXAMPLE 1

### Preparation of Transferring Film (1)

Silicone resin releasing agent was coated in a thickness of 0.1□ on the top of a 50□ thick polyethyleneterephthalate film as a substrate layer to form a release layer. Next, a composition with a viscosity of 50 cps for forming a surface treatment layer, comprising 20 parts by weight of modified acrylic resin, 10 parts by weight of vinyl acetate resin, 0.5 parts by weight of wax, 0.3 parts by weight of silicone resin, 25 parts by weight of toluene, 17 parts by weight of methyl ethyl ketone and 13 parts by weight of ethyl acetate, was coated on the top of said release layer in a thickness of 10□, using mayer bar coater, and then dried at a temperature of 120° C. to form the surface treatment layer. An adhesive being acrylamine copolymer resin was coated on the top of such formed surface treatment layer in a thickness of 2□, using mayer bar coater, and dried at 120° C. to prepare the transferring film.

### EXAMPLE 2

### Preparation of Transferring Film (2)

The transferring film was prepared by the same method as Example 1 above except for using a composition with a viscosity of 50 cps, comprising 20 parts by weight of modified acrylic resin, 10 parts by weight of vinyl acetate resin, 5 parts by weight of methyl diisocyanate, 0.5 parts by weight of wax, 0.3 parts by weight of silicone resin, 25 parts by weight of toluene, 17 parts by weight of methyl ethyl ketone and 13 parts by weight of ethyl acetate as a composition for forming a surface treatment layer.

### EXAMPLE 3

### Preparation of Transferring Film (3)

The transferring film was prepared by the same method as Example 2 except for changing methyl diisocyanate included in the composition for forming the surface treatment layer to multivalent epoxy compound.

### EXAMPLE 4

### Preparation of Substrate Sheet

A color coat layer was formed on an 100□ thick extruded film of polyvinylidene fluoride resin-methyl methacrylate resin as a transparent coat layer, using a weatherable acrylic ink. Next, an adhesion layer being urethane acrylate copolymer resin was formed on said color coat layer, and a 0.4 mm thick ABS sheet as a backing sheet was laminated thereto to prepare a weatherable substrate sheet.

### EXAMPLE 5

### Preparation of Laminate Sheet (1)

The substrate sheet (thickness: 0.5 mm) prepared in Example 4 was preheated to 130° C. in a preheating roll, and then heated to 175° C. in a heating drum to be softened. At the same time, the transferring film (1) prepared in Example 1 was heated to 150° C. with an infrared heater. Next, the adhesion layer of the heated transferring film (1) was positioned opposite to the transparent coat layer of the softened substrate sheet, and passed between a rubber roll and a steel roll to laminate the transferring film and the substrate sheet. Then, the substrate layer of transferring film (1) was released to transfer the surface treatment layer of transferring film (1). Next, a polyethylene film, in which a pressure-sensitive adhesive was applied to one side, as a protective film, was adhered to the top of surface treatment layer to prepare a laminate sheet.

### EXAMPLE 6

### Preparation of Laminate Sheet (2)

The laminate sheet was prepared by the same method as Example 5 above except for using the transferring film (2) prepared in Example 2.

### EXAMPLE 7

### Preparation of Laminate Sheet (3)

The laminate sheet was prepared by the same method as Example 5 above except for using the transferring film (3) prepared in Example 3.

### COMPARATIVE EXAMPLE 1

A color coat layer was formed on the top of an 100□ thick co-extruded film of polyvinylidene fluoride resin-methyl methacrylate resin as a transparent coat layer, using a weatherable acrylic ink. Next, an adhesion layer being urethane acrylate copolymer resin was formed thereon, and then a 0.4 mm thick ABS sheet as a backing sheet was laminated thereto to prepare a substrate sheet.

### COMPARATIVE EXAMPLE 2

The substrate sheet was prepared by the same method as Comparative Example 1 above except for using an 100□ thick methyl methacrylate resin film as a transparent coat layer.

### COMPARATIVE EXAMPLE 3

The substrate sheet was prepared by the same method as Comparative Example 1 above except for using an 100□ thick polyvinyl chloride (PVC) resin film as a transparent coat layer.

For Examples 5 to 7 and Comparative Examples 1 to 3 as prepared above, surface hardness and generation of cracks were determined by the methods indicated below.

### 1. Surface Hardness

After removing the protective film layer laminated on the surface treatment layer of the laminate sheet, a surface hardness was measured using a pencil hardness tester under a load of 500 g. In measurements, H represents a degree of hardness. As its number is increased, the degree becomes harder. Also, B represents a degree of softness. As its number is increased, the degree becomes softer.

### 2. Generation of Cracks On Tensioning After Heating

After removing the protective film layer laminated on the surface treatment layer of the laminate sheet, it was heated to 90° C. and tensioned to 200% using a tension tester at 50 mm/minute. At this time, generation of cracks was measured. If cracks were generated, this case was represented in “O.” If cracks were not generated, this case was represented in “X.”

The results measured by the above methods were represented in Table 1 below.

TABLE 1

| | | | | Comparative | | |
|---|---|---|---|---|---|---|
| | Example | | | Example | | |
| | 5 | 6 | 7 | 1 | 2 | 4 |
| Surface Hardness | H | 2H | 2H | B | B | 2B |
| Generation of Cracks | X | X | X | — | — | — |

As shown in Table 1 above, the laminate sheets according to Example 5 to 7, whose measuring results were H or 2H, had an excellent surface hardness. Especially, if the composition for forming the surface treatment layer included a hardener, they indicated more excellent surface hardness. In addition, when they were heated and tensioned, defects such as cracks were not caused. Therefore, it could be confirmed that it had an excellent drawing rate on heating.

However, the laminate sheets of Comparative Examples 1 to 3 had a poor surface hardness of B or 2B. Since the surface hardness of only transparent coat layers without any surface treatment layer was soft, it could be anticipated that scratch resistance was lowered.

### INDUSTRIAL APPLICABILITY

As described above, the transferring film and the laminate sheet of the present invention combine an excellent scratch resistance and thermoformability, since the surface treatment layer comprising modified acrylic resin and vinyl acetate is formed therein. Thus, the laminate sheet of the present invention may be effectively applied to protect and decorate plastic molded articles such as household appliances, furniture and automobile parts, especially, molded articles having a three-dimensional complicated shape.

1. A transferring film comprising a surface treatment layer comprising a modified acrylic resin and a vinyl acetate resin.

2. The transferring film of claim 1, wherein the surface treatment layer has a thickness of 3 to 20 μm.

3. The transferring film of claim 1, wherein the modified acrylic resin is one or more selected from the group consisting of urethane acrylate, amine grafted acrylate and maleic acid grafted acrylate.

4. The transferring film of claim 1, wherein the modified acrylic resin in the surface treatment layer is in an amount of 15 to 25 parts by weight.

5. The transferring film of claim 1, wherein the vinyl acetate resin in the surface treatment layer is in an amount of 5 to 15 parts by weight.

6. The transferring film of claim 1, wherein the surface treatment layer further comprises 0.5 to 1 part by weight of wax.

7. The transferring film of claim 1, wherein the surface treatment layer further comprises 0.1 to 0.5 parts by weight of a silicone resin.

8. The transferring film of claim 1, wherein the surface treatment layer further comprises 1 to 10 parts by weight of a hardener.

9. The transferring film of claim 8, wherein the hardener is one or more selected from the group consisting of an isocyanate compound, a multivalent epoxy compound and an activated polyester compound.

10. The transferring film of claim 1, wherein a carrier layer, below which a release layer is formed, is further laminated on the surface treatment layer.

11. A laminate sheet comprising a surface treatment layer transferred from the transferring film of claim 1.

12. The laminate sheet of claim 11, further comprising a protective film laminated on the surface treatment layer.

13. The laminate sheet of claim 11, further comprising a transparent coat layer formed below the surface treatment layer.

14. The laminate sheet of claim 13, wherein the transparent coat layer is a polyvinylidene fluoride resin, a methyl methacrylate resin, a blending resin of a polyvinylidene fluoride resin and a methyl methacrylate resin or a co-extruded resin of a polyvinylidene fluoride resin and a methyl methacrylate resin.

15. The laminate sheet of claim 11, further comprising a color coat layer formed below the surface treatment layer.

16. The laminate sheet of claim 15, wherein the color coat layer comprises a mixture of a weatherable ink and a binder resin.

17. A process for preparing a laminate sheet comprising steps of
(1) preparing a weatherable substrate sheet; and
(2) transferring a surface treatment layer on the substrate sheet using the transferring film of claim 1.

18. The process of claim 17, wherein the weatherable substrate sheet is prepared by forming a color coat layer and an adhesion layer in order on a transparent coat layer and laminating a backing sheet.

19. An injection molded article comprising the laminate sheet of claim 11.
